(19) United States
(12) Patent Application Publication
(10) Pub. No.: US 2015/0142281 A1
(43) Pub. Date: May 21, 2015

(54) BRAKING MANAGEMENT SYSTEM FOR A TRANSMISSION INCORPORATING A CVP

(71) Applicant: DANA LIMITED, Maumee, OH (US)

(72) Inventors: Mark R.J. Versteyhe, Oostkamp (BE); Thibaut E. Duchene, Woluwe-Saint-Lambert (BE); Evrim Taskiran, Brussells (BE)

(21) Appl. No.: 14/542,336

(22) Filed: Nov. 14, 2014

Related U.S. Application Data
(60) Provisional application No. 61/905,809, filed on Nov. 18, 2013.

(51) Int. Cl. B60W 30/18; B60W 10/04; F16H 61/21; B60W 10/184; B60W 10/196; B60W 10/02; B60W 10/108

(52) U.S. Cl. CPC B60W 30/18136; B60W 30/18181; B60W 10/02; B60W 10/04; B60W 10/108; B60W 10/184; B60W 10/196; F16H 61/21
USPC 701/54

(57) ABSTRACT

A braking management system for a vehicle having a driveline that has a transmission featuring a continuously variable planetary variator, the braking management system comprising a processor adapted to actuate one or more braking mechanisms based on current state of the vehicle and a braking input from a vehicle operator. The system may prioritize some mechanisms over others to optimize vehicle efficiency or vehicle component longevity.

### CROSS-REFERENCE TO RELATED APPLICATIONS

This application claims the benefit of U.S. Provisional Application No. 61/905,809, filed Nov. 18, 2013, which application is incorporated herein by reference.

### BACKGROUND OF THE INVENTION

Automatic and manual transmissions are commonly used on automotive vehicles, such as cars, trucks and Off-Highway Vehicles. Both conventional automatic and manual transmissions are restricted to a select few gear ratios, in order to enable a wide range of vehicle speeds while keeping the vehicle's internal combustion engine (ICE) operating within its limited operating engine speed range. Within the usable range of engine speeds for an ICE, there are optimal speeds for efficiency and power generation. Due to the discreet gear ratios of conventional automatic and manual transmissions, operating ICE vehicles at these optimal engine speeds is restricted to discreet vehicle speeds. Those transmissions are becoming more and more complicated since the engine speed has to be more precisely controlled to limit the fuel consumption and the emissions of cars. This finer control of the engine speed in usual transmissions can only be done by adding more discrete step ratio gears and increasing the overall complexity and cost. Consequently, 6-speed manual transmissions then become more frequently used as are 8 or 9 speed automatic transmissions. While adding additional gears to conventional transmissions can help the user operate the vehicle at optimal rpm ranges for a greater corresponding range of vehicle speeds, doing so adds significant cost and complexity to the transmission. Continuously variable transmissions (CVT) on the other hand can steplessly operate at an infinite number of gear ratios between low gear ratio and a high gear ratio. CVTs are of many types: belts with variable pulleys, toroidal, and conical to name a few. This ability to operate at a continuous range of gear ratios allows an automotive vehicle to operate at a constant ICE engine speed over a broad range of vehicle speeds. The main advantage of a CVT is that it enables the engine to run at its most efficient rotation speed by changing steplessly the transmission ratio as a function of the vehicle speed. Moreover, the CVT can also shift to a ratio providing more power if higher acceleration is needed. A CVT can change the ratio from the minimum to the maximum ratio without any interruption of power, unlike conventional transmissions which cause an interruption of power during ratio shifts. Furthermore, such capabilities allow for the optimization of the ICE design for narrow but more efficient power bands, allowing greater useable power from smaller displacement more economical engines. A specific use of CVTs is the Infinite Variable Transmission or IVT. Whereas the CVT is limited at positive speed ratios, the IVT configuration can perform a neutral gear and even reverse ratios continuously. A CVT can also be used as an IVT in some driveline configurations.

A typical CVT design example is the Fallbrook “NuVinci” Technology, which is a rolling traction drive system, transmitting forces between the input and output rolling surfaces through shearing a thin fluid film. NuVinci designs utilize a continuously variable planetary (CVP) variator, which steplessly operates through a range of speed ratios. The technology is called “Continuously Variable Planetary” (CVP) due to its analogous operation to a planetary gear system. The system consists of an input disc (ring) driven by the power source, an output disc (ring) driving the CVP output and a set of balls rotating on its own axle (planets) and is fitted between these two discs and a central sun.

The torque from the input power source is transferred between input ring, balls and output ring using a thin layer of traction fluid (elasto-hydrodynamic lubrication—EHL). The discs are clamped onto the balls tightly to achieve the clamping force required to transmit the torque.

The relative speed of the output ring is controlled by tilting the angle of the ball axles relative to the transmission axis. By tilting the ball axles the CVP can operate steplessly within a range of speed ratios. Typically the speed ratio range spans underdrive to overdrive ratios.

Much of the development effort behind CVTs and CVPs is motivated by a desire for increased efficiency. Further gains in efficiency may be accomplished by improved braking methods tailored towards vehicle drivelines having CVTs and CVPs. There exists a current need for advanced braking methods for such vehicle drivelines.

### SUMMARY OF THE INVENTION

Aspects of the disclosure provide systems and methods for braking a vehicle having a vehicle driveline with a transmission featuring a CVP variator. In many embodiments such systems comprise a processor (also referred to as sub-control unit), the processor being operably connected to the vehicle driveline and adapted to actuate one or more of the following braking mechanisms:

a. an engine selectively coupleable to the vehicle driveline and configured to exert a braking torque on the driveline;

b. a CVP drivingly engaged with the engine and configure to rev-up the engine by altering its speed ratio and routing power from the vehicle driveline to the engine, thereby transferring the vehicle's kinetic energy into the kinetic energy of the engine, and thus braking the vehicle;

c. frictional losses in the CVP;

d. clutches in the transmission of the vehicle driveline;

e. service brakes coupled to the vehicle driveline;

f. one or more centrifugal brakes coupled to the vehicle driveline; or

g. one or more additional brakes coupled to the vehicle driveline

In many embodiments, the braking management system's processor is adapted to estimate the requisite amount of braking power needed from the one or more braking mechanisms (a)-(g) based on a known mass of the vehicle, passive frictional losses throughout the vehicle driveline and a braking input from a vehicle operator.

In many embodiments the processor is adapted to prevent damage to the vehicle or its associated driveline from braking or braking related activities. In some embodiments the processor is adapted to prevent the engine from revving over a pre-determined engine speed (redline, or another user specified value) when actuating the brake mechanism (b). Additionally, in some embodiments the processor is adapted to prevent overheating of a traction fluid in the CVP, when actuating the brake mechanism (c).

In many embodiments, the processor is adapted to calculate a maximal braking power for each braking mechanism for a given state of the vehicle and given limitations of the vehicle driveline components. A given state of the vehicle may comprise at least one of the following: a current speed of the vehicle, a current speed of the engine, a current temperature of a traction fluid in the CVP, a current temperature of one or more fluids. In some embodiments the processor is adapted to select and actuate a combination of one or more braking mechanisms at one or more baking powers with the maximal braking power for each respective chosen braking mechanism. In further embodiments, the processor may be adapted to select certain braking mechanisms in order to optimize a fuel economy of the vehicle.

In many embodiments, the processor is adapted to select and actuate a combination of the one or more braking mechanisms at one or more braking powers within the calculated maximal braking power for each respective braking mechanism, while optimizing a longevity of one or more components of the vehicle driveline.

Aspects of the present disclosure provide a method of braking a vehicle, the method comprising: providing any of the braking management systems described above, and actuating one or more of the braking mechanisms via the braking management system, thereby braking the vehicle.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an exemplary configuration of the main elements of a CVP.

FIG. 2 illustrates the general working principle of a ball-type CVT including the ratio change in the CVP.

FIG. 3 illustrates how the basic driveline configuration of a CVT is used to replace a traditional transmission and is located between the engine (ICE or internal combustion engine or other power source) and the differential.

FIG. 4 illustrates a typical centrifugal brake based on springs and flyweights.

FIG. 5 is a centrifugal brake based on a wet clutch.

FIG. 6 illustrates a representative braking management system.

### DETAILED DESCRIPTION OF THE INVENTION

A specific use of CVTs is the Infinite Variable Transmission or IVT. Whereas the CVT is limited to positive speed ratios, the IVT configuration can perform a neutral gear and even reverse ratios steplessly. A CVT can be used as an IVT in some driveline configurations.

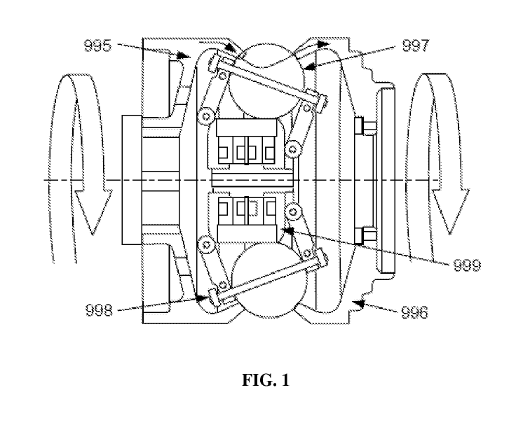

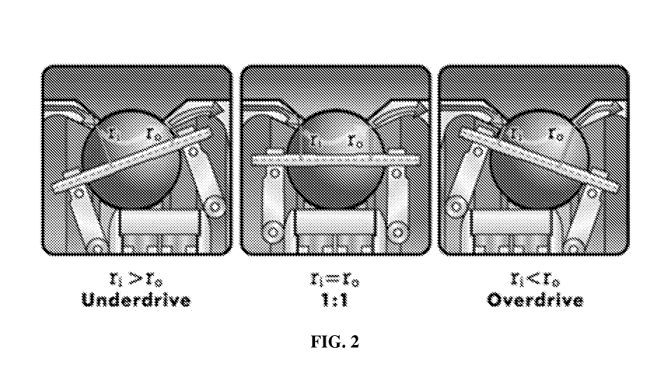

Provided herein are configurations based on a ball type CVT, also known as CVP, for constant variable planetary. Aspects of the CVTs are described in US20040616399 or AU2011224083A1, incorporated herein by reference in their entirety. The type of CVT used herein is composed of a plurality of variator balls, 997, as shown on FIG. 1, depending on the application, two discs (input disc, 995, and output disc, 996) or annular rings each having an engagement portion that engages the variator balls, 997. The engagement portions may be in a conical or toroidal convex or concave surface contact with the variator balls, 997, as input and output. The CVT may include an idler, 999, contacting the balls, 997, as well as shown on FIG. 1. The variator balls, 997, are mounted on axes, 998, themselves held in a cage or carrier allowing changing the ratio by tilting the variator balls' axes, 998. Other types of ball CVTs also exists, like the one produced by Milner but are slightly different. These alternative ball CVTs are additionally contemplated herein. The working principle generally speaking, of a ball-type CVT is shown in FIG. 2.

The CVP itself works with a traction fluid. The lubricant between the ball and the conical rings acts as a solid at high pressure, transferring the power from the first ring assembly, through the variator balls, to the second ring assembly. By tilting the variator balls' axes, the ratio can be changed between input and output. When the axis of each of the variator balls is horizontal the ratio is one, when the axis is tilted the distance between the axis and the contact point change, modifying the overall ratio. All the variator balls' axles are tilted at the same time with a mechanism included in the cage.

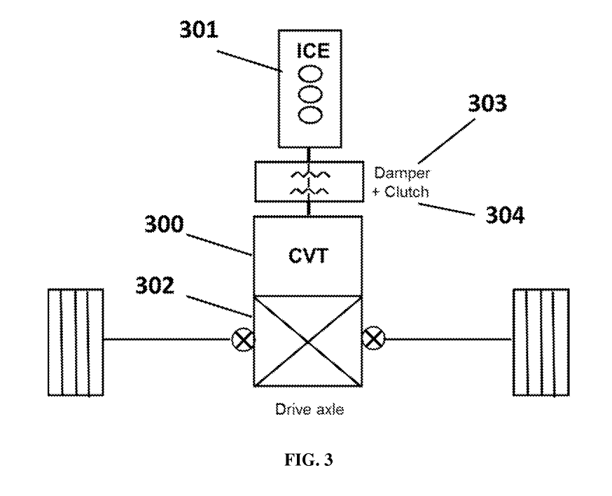

In a car, the CVT, 300, is used to replace traditional transmission and is located between the engine (ICE, 301, or internal combustion engine, or any other power plant) and the differential, 302, as shown on FIG. 3. A torsional dampener, 303, (alternatively called a damper) may be introduced between the engine, 301, and the CVT, 300, to avoid transferring torque peaks and vibrations that could damage the CVT, 300. In some configurations this dampener, 303, can be coupled with a clutch, 304, for the starting function.

In addition to the configurations above where the variator is used directly as the primary transmission, other architectures are possible. Various powerpath layouts can be introduced by adding a number of gears, clutches and simple or compound planetary gear sets. In such configurations, the overall transmission can provide several operating modes; a CVT, an IVT, a combined mode and so on.

The present disclosure provides braking management systems and methods for a vehicle having CVP based transmissions such as CVTs and IVTs, see descriptions above.

In preferred embodiments such systems draw upon a multitude of braking mechanisms and control the braking mechanisms to achieve enhance efficiency and breaking performance. The braking mechanisms include all the methods that might dissipate the energy of a vehicle during braking; both active and passive methods may be included. Such braking mechanisms may comprise at least one of the following: Engine braking, Engine rev-up, losses in driveline components, losses in the CVP, clutches in the transmission, service brakes, additional centrifugal brakes, and additional brakes.

Many embodiments of the braking management system are configured to perform engine braking in order to brake the vehicle. Engine braking includes all the losses related to the engine. Although there are active ways to control the engine braking for the new engine models, the methods an systems explained here covers the passive losses that can be estimated mainly based on the engine speed. This engine braking torque can thus be indirectly controlled by adjusting the speed of the engine and by setting the amount of fuel that is sent to the engine.

In a driveline including a CVP, the engine speed is not directly related to the vehicle speed and it is possible to adjust the engine speed to provide more (high speed) or less (low speed) engine braking. However, this parameter is limited by the extreme ratios that the transmission can achieve. If the transmission contains several modes and especially an IVT, the engine will have more freedom to operate than if the transmission only contains a CVT mode (i.e. a limited positive spread). A safety mechanism might be necessary to limit the over-speeding (red-lining) of the engine, (e.g. by limiting speed ratio rate) in case the speed ratio is rapidly set to very small values, especially in an IVT configuration.

Additionally, the engine braking might be set to its maximum value or some fuel can be added to decrease the torque absorbed by the engine. The amount of fuel injected can be regulated between 0, for full engine braking, and a value that will create just enough torque to balance the losses and engine accessory torque requests. A perfect example of fuel injection is the idle, during which the engine is kept to a constant speed by injecting fuel to balance the other losses. As torque sensors are typically not available in vehicles, the engine braking is typically computed from a lookup table that has been established offline (based on engine measurement data).

In many preferred embodiments the braking management system may vary the variator speed ratio while the vehicle's drive train is engaged with the engine to use the vehicles momentum to rev the vehicles engine. In this manner the braking management system brakes the vehicle by transferring the vehicle's kinetic energy into the engine and typically the engine's flywheel. Such embodiment may further comprise a safety feature that prevents the variator from over-revving (red-lining) the engine in order to prevent damage to the inner components of the engine. For small vehicles (or for braking cases where the vehicle speed is lower than a certain number), only this solution might be sufficient to store most of the braking energy (while staying under the limit of the engine, for safety issues and to avoid excessive noise).

An advantage of revving the engine with the transmission to brake the vehicle is that the energy stored during braking can be re-used when accelerating. This is a particularly important feature for off-highway vehicles that perform a lot of repetitive cycles including consecutive braking and accelerations.

The energy stored by revving up the engine can be set by choosing the speed ratio of the variator, determining the speed of the engine. Furthermore, the torque can be easily estimated knowing the inertia of the different components.

Finally, the amount of energy that can be stored as kinetic energy is especially important in applications having a CVT or an IVT (allowing a bigger speed range); where the engine speed is preferably kept at lower values than conventional transmissions.

In many embodiments the braking management system may take into account inherent braking of the vehicle, at least in part, by taking into account the passive losses inherent throughout the driveline. In such embodiments, a part of the braking energy will also be dissipated by all driveline components that cause friction. Friction causing components may include but are not limited to: the rolling friction at the tires, losses at the bearings, and losses at seals. Although the vehicle manufacturers work on minimizing these losses to improve fuel economy (same losses remain during acceleration increasing fuel consumption), still a certain amount of friction resistance torque will help in the braking of the vehicle. One of the main components of this passive friction in vehicles is the rolling resistance in the tires.

Many exemplary embodiments of the braking management system brake the vehicle with frictional losses in the CVP itself. The CVP is a significant source of losses; especially at extreme ratios in which the spin losses dramatically increase. It is thus possible to actively set the loss in the CVP by setting the speed ratio to deliberately use the CVP in low efficiency range.

Additionally, for transmission having power split layouts, it is possible to set the ratio of the CVP to be in an area in which there is re-circulative power in the CVP (i.e. increasing the losses in the driveline significantly).

It has to be noted that heat dissipation in the CVP and the powersplit layouts; e.g.: planetaries, gears, clutches, etc., is critical and the braking control unit has to take this into account in order not to exceed the limit temperature of the oil at some points.

Efficiency maps of the CVP, created by efficiency testing or based on simulations, are the determining factor in controlling the loss model of the CVP.

In many embodiments the vehicle's CVT may be capable of multi-mode configurations, wherein modes are selected through the use of mode selecting clutches to selectively link or engage different transmission power pathways. In such embodiments the braking management system may brake the vehicle, at least in part, by dissipating kinetic energy with the transmission's mode selecting clutches. Typically one mode selecting clutch will be engaged while the clutch for a different mode is allowed to slip thereby dissipating the vehicles kinetic energy via the driveline.

In many embodiments braking management system may brake the vehicle with one or more service brakes. Services brakes of the vehicles can also be used to provide some braking. In regular situations, these brakes are only rarely used (e.g. emergency cases or necessary hard-stops). These brakes typically contain wet or dry clutches and thus the energy dissipation (their temperature) has to be taken into account.

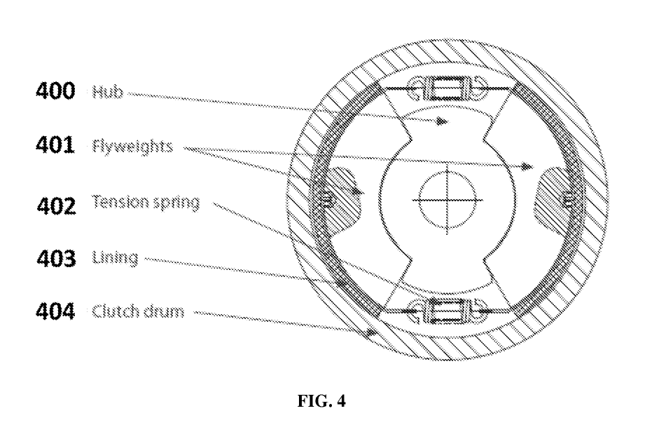

In many embodiments the braking management system may brake the vehicle with a centrifugal brake. If the braking management system is unable to provide sufficient braking via the above mentioned means, the braking management system may also employ one or more centrifugal brakes. Centrifugal brakes have the specificity to engage passively from a certain speed (adjusted by the designer). Additionally, their braking capacity also increases with speed. FIG. 4 shows a typical centrifugal brake based on springs, 402, and flyweights, 401 further comprising a hub, 400, tension spring, 402, and lining, 403. This type of centrifugal brake is highly adaptable for all kind of solutions, as many of their operating features; e.g. engagement speed, their size, the torque created, etc., can be set to match the application-specific requirements. The design parameters such as the mass of the flyweights, the diameter, the spring constant, the distance between the flyweights, 401, and the drum, 404, can be chosen such that the design meets the specifications required.

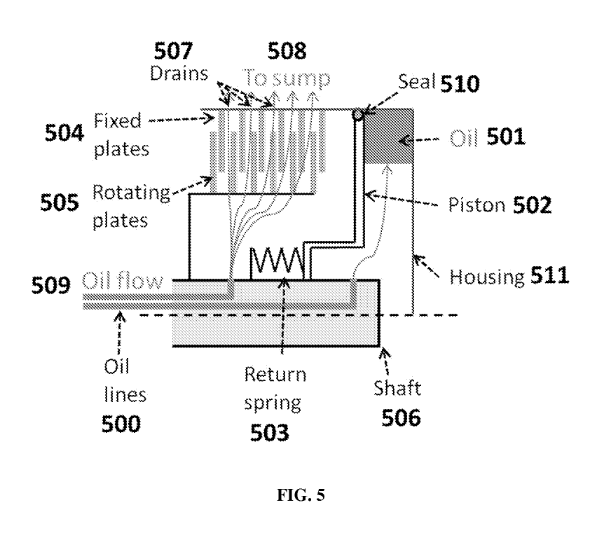

Centrifugal brakes can also be applied in different ways. For example, FIG. 5 shows a centrifugal brake based on a wet clutch. The shaft includes two oil lines, 500, which may be controlled independently of one another. One oil line directs oil, 501, against a piston face, 502, contained within a housing, 511. The oil pressure increases due to centrifugal forces. When the force arising from the oil pressure is greater than that of the spring, 503, the piston, 502, will move and transfer its motion to the fixed plates, 504, which then frictionally engage the rotating plates, 505, connected to the shaft, 506. Rotational energy from the shaft, 506, is dissipated as heat by the slipping plates, 504 and 505, thus achieving braking action. As noted earlier, additional energy and frictional losses will also occur in areas such as the seals, 510. The other oil line directs oil, 501, through the plates, 504 and 505, to several drains, 507, which drain to a sump, 508, in order to cool the clutch plates. The drains, 507, also function to prevent oil, 501, from gathering on the left side of the piston, 502.

This system can be controlled by controlling the oil flow, 509, to the back and to the front of the piston, 502. Stopping the flow, 509, to the back of the piston, 502, will make the brake inoperable and stopping the flow, 509, to the plates, 504 and 505, will highly reduce the drag losses.

Some embodiments feature additional wet or dry clutches to act as brakes for use by the braking management system.

In exemplary embodiments, the braking management system may brake the vehicle with any one or more of the above mentioned braking mechanisms (Engine braking, Engine rev-up, losses in the CVP, clutches in the transmission, service brakes, centrifugal brakes, and additional brakes). The braking management system may further comprise a sub-control unit adapted to handle prioritization, coordination, management, and utilization of the braking mechanisms. For instance, one or more of the above mentioned braking mechanisms may be appropriately used but each mechanism may be called upon to provide different amounts of braking force depending on the current state of the vehicle. Some braking mechanisms, such as passive losses throughout the drive line must be taken into account by the sub-control unit. In some embodiments, the sub-control unit may be part of a master control unit of the vehicle.

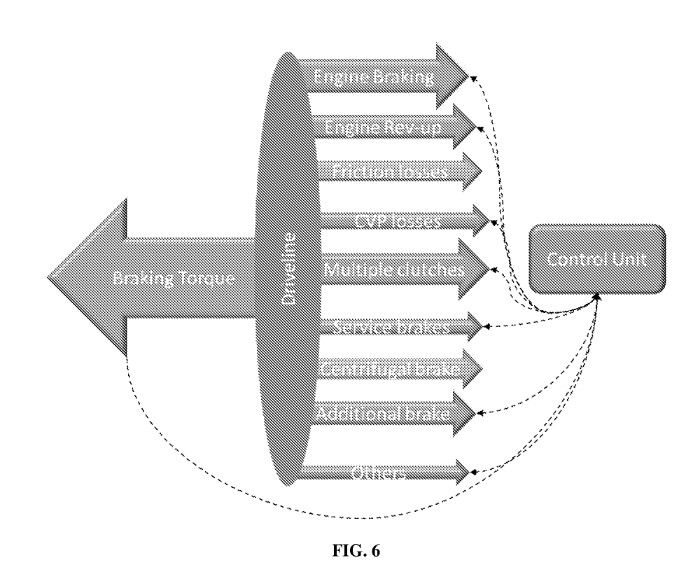

In many embodiments, the sub-control unit is adapted to estimate the amount of braking needed with knowledge of the mass of the vehicle and the position of the brake pedal. The sub-control unit may then assess the amount of braking force each braking mechanism may provide, given the current state of the vehicle. Such a state may comprise engine speed, vehicle speed, and rotational speed of various other components of the driveline (such as clutches, differentials, and centrifugal brakes). The sub-control unit may be further adapted to prioritize which braking mechanisms to use based on the desired braking situation. Hard braking will necessitate fast acting powerful brakes. Soft braking may favor revving the engine in order to later utilize energy stored in the engine and improve efficiency. The sub-control unit may also be adapted to prevent any one braking mechanism from being used beyond a safe design limit. For example the sub-control unit may utilize engine revving and shut off fuel to the engine to maximize engine braking but will cease to draw more braking power from these braking mechanisms when the engine speed approaches redline (the design limit of the engine). At this point the sub control unit will actuate other braking mechanisms such as centrifugal brakes or clutches. The sub-control unit may also be adapted to prevent overutilization of the clutches and CVP to avoid overheating or failure in any of these components. The sub control unit may also be configured to alter a state of the vehicle to alter braking forces from any of the braking mechanisms. For example the sub-control unit may increase engine speed to augment engine breaking. FIG. 6 shows the sub-control unit (labeled as control unit) receiving data on each of the potential breaking mechanisms and from there executes a braking torque form the vehicle driveline using one or more the available braking mechanisms. The sub-control unit may prioritize at least one or more of the following when selecting which braking mechanisms to apply: vehicle efficiency, driveline component, vehicle longevity, and/or braking power.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A braking management system for a vehicle driveline having a transmission incorporating a CVP, the system comprising:
a processor (sub-control unit) operably connected to the vehicle driveline and adapted to actuate one or more of the following braking mechanisms:
(a) an engine selectively coupleable to the vehicle driveline and configured exert a braking torque on the driveline;
(b) a CVP drivingly engaged with the engine and configure to rev-up the engine by altering its speed ratio and routing power from the vehicle driveline to the engine, thereby transferring the vehicle's kinetic energy into the kinetic energy of the engine, and thus braking the vehicle;
(c) frictional losses in the CVP;
(d) clutches in the transmission of the vehicle driveline;
(e) service brakes coupled to the vehicle driveline;
(f) one or more centrifugal brakes coupled to the vehicle driveline; or
(g) one or more additional brakes coupled to the vehicle driveline

2. The braking management system of claim 1, wherein the processor is adapted to estimate a requisite amount of braking power needed from the one or more braking mechanisms (a)-(g) based on a known mass of the vehicle, passive frictional losses throughout the vehicle driveline and a braking input from a vehicle operator.

3. The braking management system of claim 2, wherein the processor is adapted to prevent the engine from revving over a pre-determined engine speed when actuating braking mechanism (b).

4. The braking management system of claim 2, wherein the processor is adapted to prevent overheating of a traction fluid in the CVP when actuating braking mechanism (c).

5. The braking management system of claim 2, wherein the processor is adapted to prevent overheating in the brakes or clutches of the vehicle driveline when actuating one or more of braking mechanisms (d), (e), (f), or (g).

6. The braking management system of claim 2, wherein the processor is adapted to calculate a maximal braking power for each braking mechanism for a given state of the vehicle and given limitations of the vehicle driveline components, wherein a given state of the vehicle comprises at least one of the following: a current speed of the vehicle, a current speed of the engine, a current temperature of a traction fluid in the CVP, a current temperature of one or more coolant fluids.

7. The braking management system of claim 6, wherein the processor is adapted to select and actuate a combination of one or more braking mechanisms at one or more braking powers with the maximal braking power for each respective braking mechanism, while optimizing a fuel economy of the vehicle.

8. The braking management system of claim 6, wherein the processor is adapted to select and actuate a combination of one or more braking mechanisms at one or more braking powers with the maximal braking power for each respective braking mechanism, while optimizing a longevity of one or more components of the vehicle driveline.

9. A method of braking a vehicle, the vehicle having a driveline with a transmission having a CVT, the method comprising:
providing a braking management system, as recited in claim 1;
actuating one or more of the braking mechanisms via the braking management system, thereby braking the vehicle.
